(19) United States
(12) Patent Application Publication
(10) Pub. No.: US 2014/0295163 A1
(43) Pub. Date: Oct. 2, 2014

(54) PRESS MOLDED ARTICLE, AND METHOD AND APPARATUS FOR PRODUCING SAME

(71) Applicant: TAKAGISEIKO CORPORATION, Takaoka, Toyama (JP)

(72) Inventors: Satoshi Kohsaka, Takaoka (JP); Akio Yanamoto, Takaoka (JP); Katsuyuki Inami, Takaoka (JP)

(21) Appl. No.: 14/355,710

(22) PCT Filed: Nov. 1, 2012
(86) PCT No.: PCT/JP2012/078347

§ 371 Date: May 1, 2014

(30) Foreign Application Priority Data
Nov. 2, 2011 (JP) 2011-241338

(51) Int. Cl. B29C 51/12; B32B 27/32; B32B 27/34; B32B 27/12

(52) U.S. Cl. CPC B29C 51/12; B32B 27/12; B32B 27/32; B32B 27/34
USPC 428/220; 264/322; 425/174

(57) ABSTRACT

The present invention provides: a method and apparatus for producing a press molded article from a sheet that contains carbon fibers and a thermoplastic resin, said method and apparatus having improved production efficiency by reducing the heating time; and a press molded article which contains carbon fibers and a thermoplastic resin and is prevented from deterioration in the properties inherent in the starting materials. The present invention provides a press molded article containing carbon fibers and a thermoplastic resin, which is characterized in that: (i) the carbon fibers are contained in an amount of 5-50 vol % in 100 vol % of the press molded article; (ii) the press molded article has a volume resistivity of from 5×10⁻³ to 1×10⁻¹ Ω·cm; and (iii) the press molded article has a thickness of 0.25-30 mm.

### TECHNICAL FIELD

The present invention relates to a press molded article comprising carbon fibers and a thermoplastic resin as well as a method and an apparatus for producing the press molded article.

### BACKGROUND ART

A composite material comprising carbon fibers and a thermoplastic resin is conventionally known in the prior art. Since the composite material has its strength and lightweight, the composite material is used as various parts and products such as aircraft parts, automotive structural members, and the like.

These products have been obtained by molding a sheet-like material comprising carbon fibers and a thermoplastic resin into desired shapes by using a hot press molding method. Specifically, in the hot press molding method, the products have been obtained by heating the thermoplastic resin up to around its melting point or higher with an external heating process such as a far infrared or infrared heater, an IH heater, or the like, followed by hot press molding the sheet-like material into desired shapes (see Patent Document 1). Furthermore, the Patent Document 1 has a line describing an electrical conduction heating process in addition to the hot press molding process. The description, however, is referred to in a case where a thermosetting resin is used.

### PRIOR ART

### PATENT DOCUMENT

Patent Document 1: WO 2007/013544.

### SUMMARY OF THE INVENTION

### Problems to be solved by the Present Invention

However, the conventional hot press molding process has a problem that increased thickness of the sheet-like material requires longer time for heating the sheet-like material from outside of the sheet-like material and thus longer time for hot press molding, resulting in poor production efficiency. Further, there has been a problem that, when a wider area of the sheet-like material is used, the material cannot be heated evenly. Solving the problem has resulted in another problem that heating time becomes longer, i.e., resulting in poor production efficiency.

Further, in addition to the poor production efficiency, there has been a problem based on the decreased properties of the resulting press molded articles, that are inherent to the starting materials of the articles due to oxidative degradation of the constituent resin.

An object of the present invention is to solve the above-described problems.

Specifically, an object of the present invention is to provide a method and an apparatus for producing a press molded article from a sheet comprising carbon fibers and a thermoplastic resin, said method and apparatus providing improved production efficiency with decreased heating time.

Further, in addition to, or other than the above-described objects, an object of the present invention is to provide a press molded article comprising carbon fibers and a thermoplastic resin, which is prevented from deterioration of the properties, for example, mechanical performances, which are inherent to the starting materials.

### Means for solving the Problems

The present inventors have found the following inventions:

<1> A press molded article comprising carbon fibers and a thermoplastic resin, wherein
i) an amount of the carbon fibers ranges from 5 to 50 vol %, preferably 10 to 30 vol % in 100 vol % of the press molded article,
ii) a volume resistivity of the press molded article ranges from 5×10⁻³ to 1×10⁻¹ Ω·cm, preferably from 2×10⁻² to 9×10⁻² Ω·cm, and
iii) a thickness of the press molded article ranges from 0.25 to 30 mm.

Furthermore, the press molded article may preferably have a portion entirely having a thickness ranging from 2 to 25 mm.

<2> In the above item <1>, iv) an infrared absorption spectral intensity of the press molded article may have 0.05 or less, preferably 0.03 or less between the base lines in a wavenumber range of 1720 to 1770 cm⁻¹, as measured by a Fourier transform infrared spectrophotometer (FT-IR).

<3> In the above item <1> or <2>, the carbon fibers may form a carbon fiber layer.

<4> In any one of the above items <1> to <3>, the thermoplastic resin may be at least one selected from the group consisting of polyesters, polyolefins, polystyrenes, polyurethanes, polyamides, polyimides, polyketones, polycarbonates, polysulfones, and polyethers. Preferably, the thermoplastic resin may be polypropylene, polyamide, polyphenylene sulfide, or modified polyphenylene ether.

<5> A method for producing a press molded article comprising carbon fibers and a thermoplastic resin from a sheet comprising carbon fibers and a thermoplastic resin, the method comprising the steps of:
A) preparing the sheet comprising carbon fibers and the thermoplastic resin, in particular, the sheet having a thickness ranging from 0.25 to 30 mm;
B) heating the sheet by electrical conduction to transform the sheet into a plastic state; and
C) press molding the sheet in a plastic state; to obtain the press molded article.

Furthermore, the above A) sheet may preferably have a portion entirely having a thickness ranging from 2 to 25 mm.

<6> In the above item <5>, an amount of the carbon fibers may range from 5 to 50 vol %, preferably 10 to 30 vol % in 100 vol % of the sheet.

<7> In the above item <5> or <6>, a volume resistivity of the sheet may range from 5×10⁻³ to 1×10⁻¹ Ω·cm, preferably from 2×10⁻² to 9×10⁻² Ω·cm.

<8> In any one of the above items <5> to <7>, an amount of the carbon fibers may range from 5 to 50 vol %, preferably 10 to 30 vol % in 100 vol % of the press molded article.

<9> In any one of the above items <5> to <8>, a volume resistivity of the press molded article may range from 5×10⁻³ to 1×10⁻¹ Ω·cm, preferably from 2×10⁻² to 9×10⁻² Ω·cm.

<10> In any one of the above items <5> to <9>, a thickness of the press molded article may be 0.25 to 30 mm. Preferably, the press molded article may have a portion entirely having a thickness ranging from 2 to 25 mm.

<11> In any one of the above items <5> to <10>, an infrared absorption spectral intensity of the press molded article may have 0.05 or less, preferably 0.03 or less between the base lines in a wavenumber range of 1720 to 1770 cm⁻¹, as measured by a Fourier transform infrared spectrophotometer (FT-IR).

<12> An apparatus for producing a press molded article comprising carbon fibers and a thermoplastic resin, comprising:
X) an electrical conduction heating means for heating a sheet comprising carbon fibers and a thermoplastic resin; and
Y) a press molding means for press molding the sheet in a plastic state obtained by the electrical conduction heating means.

Furthermore, the above X) sheet may preferably have a portion entirely having a thickness ranging from 2 to 25 mm.

<13> In the above item <12>, X) the electrical conduction heating means and Y) the press molding means may be arranged so that the sheet in a plastic state obtained by the electrical conduction heating means can be immediately press molded.

<14> In the above item <12> or <13>, an amount of the carbon fibers may range from 5 to 50 vol %, preferably 10 to 30 vol % in 100 vol % of the sheet.

<15> In any one of the above items <12> to <14>, a volume resistivity of the sheet may range from 5×10⁻³ to 1×10⁻¹ Ω·cm, preferably from 2×10⁻² to 9×10⁻² Ω·cm.

<16> In any one of the above items <12> to <15>, an amount of the carbon fibers may range from 5 to 50 vol %, preferably 10 to 30 vol % in 100 vol % of the press molded article.

<17> In any one of the above items <12> to <16>, a volume resistivity of the press molded article may range from 5×10⁻³ to 1×10⁻¹ Ω·cm, preferably from 2×10⁻² to 9×10⁻² Ω·cm.

<18> In any one of the above items <12> to <17>, a thickness of the press molded article may be 0.25 to 30 mm. Preferably, the press molded article may have a portion entirely having a thickness ranging from 2 to 25 mm.

<19> In any one of the above items <12> to <18>, an infrared absorption spectral intensity of the press molded article may have 0.05 or less, preferably 0.03 or less between the base lines in a wavenumber range of 1720 to 1770 cm⁻¹, as measured by a Fourier transform infrared spectrophotometer (FT-IR).

### The Effects of the Present Invention

The present invention can solve the above-described problems.

Specifically, the present invention can provide a method and an apparatus for producing a press molded article from a sheet comprising carbon fibers and a thermoplastic resin, said method and apparatus providing improved production efficiency with decreased heating time.

Further, in addition to, or other than the above-described effects, the present invention can provide a press molded article comprising carbon fibers and a thermoplastic resin, which is prevented from deterioration of the properties, for example, mechanical performances, which are inherent to the starting materials.

### BRIEF DESCRIPTION OF DRAWING

FIG. 1 shows one embodiment of an apparatus for producing a press molded article and outlining a state of electrical conduction heating and a subsequent pressed state (shaping state).

### EMBODIMENTS FOR CARRYING OUT THE PRESENT INVENTION

The present invention will be described in detail hereinafter.

The present application provides a press molded article comprising carbon fibers and a thermoplastic resin, especially one which is prevented from deterioration of the properties, for example mechanical performances, which are inherent to the starting materials, due to the oxidative degradation of the constituent resin.

Further, the present invention provides a method and an apparatus for producing the press molded article, in particular, a method and an apparatus for producing the press molded article from a sheet comprising carbon fibers and a thermoplastic resin.

Those will be described in order hereinafter.

### <Press Molded Article>

The present application provides a press molded article comprising carbon fibers and a thermoplastic resin, especially a press molded article comprising carbon fibers and a thermoplastic resin which is prevented from deterioration of the properties, for example mechanical performances, which are inherent to the starting materials, due to the oxidative degradation of the constituent resin.

The press molded article of the present application may have the carbon fibers in an amount of 5 to 50 vol %, preferably 10 to 30 vol % in 100 vol % of the press molded article.

The press molded article of the present application may have a volume resistivity of 5'31⁻³ to 1×10⁻¹ Ω·cm, preferably 2×10⁻² to 9×10⁻² Ω·cm. Since the carbon fibers in the press molded article of the present application has electrical conductivity, a volume filling ratio may have the above-described range. More specifically, the volume resistivity may have the above-described range.

The press molded article of the present application may have a thickness of 0.25 to 30 MM.

Furthermore, the phrase “thickness of 0.25 to 30 mm” used herein means that, when a thickness of a certain thing is uniform, the uniform thickness ranges from 0.25 to 30 mm, and that, when a thickness of a certain thing is not uniform, all the non-uniform thicknesses range from 0.25 to 30 mm.

Preferably, the press molded article may have a portion entirely having a thickness ranging from 2 to 25 mm.

Furthermore, the phrase “a portion entirely having a thickness ranging from 2 to 25 mm” used herein means that, when a thickness of a certain thing is uniform, the uniform thickness ranges from 2 to 25 mm, and that, when a thickness of a certain thing is not uniform, the presence of the portion having a thickness of 2 to 25 mm means that the certain thing has a portion having a thickness belonging to the range.

An infrared absorption spectral intensity of the press molded article of the present application may have 0.05 or less, preferably 0.03 or less between the base lines in a wavenumber range of 1720 to 1770 cm⁻¹, as measured by a Fourier transform infrared spectrophotometer (FT-IR). Here, the infrared absorption spectral intensity in the wavenumber range of 1720 to 1770 cm⁻¹ is measuring a degree of oxidation of the thermoplastic resin in the press molded article, specifically, an infrared absorption spectrum derived from an oxidized substance, a carbonyl group. When the intensity thereof is in the range described above, the degree of oxidation is low, and thus, the press molded article is preferable.

As the thermoplastic resin of the press molded article of the present application, almost all thermoplastic resins can be used, ranging from a general-purpose plastic to a super engineering plastic. Specifically, the resin may be at least one selected from the group consisting of polyesters, polyolefins, polystyrenes, polyurethanes, polyamides, polyimides, polyketones, polycarbonates, polysulfones, and polyethers. Preferably, the thermoplastic resin may be polypropylene, polyamide, polyphenylene sulfide, or modified polyphenylene ether.

In the press molded article of the present application, the carbon fibers may be contained in any form as long as they have the above-described volume filling ratio and/or volume resistivity. For example, the press molded article of the present application may be, but is not limited to, one having carbon fibers dispersed in a predetermined orientation in a thermoplastic resin. When the carbon fibers is dispersed in a predetermined orientation, the form thereof is not particularly limited. For example, the carbon fibers may form a layer in the press molded article. Furthermore, examples of the orientation may include, but are not limited to, roving, random, plain weave, web and the like.

Each carbon fiber is not particularly limited in its form. However, the fiber may have a diameter of about 1 μm to about 30 μm, and a length of about 1 mm to about 100 mm.

<A Method for Producing a Press Molded Article from a Sheet Comprising Carbon Fibers and a Thermoplastic Resin> and <An Apparatus for Producing a Press Molded Article from a Sheet Comprising Carbon Fibers and a Thermoplastic Resin>

Next, a method and an apparatus for producing a press molded article from a sheet comprising carbon fibers and a thermoplastic resin will be described. Hereinafter, the production method will be mainly described and the apparatus will be referred to, if necessary.

The method for producing the press molded article of the present application comprises the steps of:
A) preparing a sheet comprising carbon fibers and a thermoplastic resin, in particular, the sheet having a thickness of 0.25 to 30 mm;
B) heating the sheet by electrical conduction to transform the sheet into a plastic state; and
C) press molding the sheet in a plastic state; thereby to produce the press molded article comprising carbon fibers and a thermoplastic resin.

Further, an apparatus for producing the press molded article of the present application comprises:
X) an electrical conduction heating means for heating the sheet by electrical conduction, the sheet comprising carbon fibers and a thermoplastic resin, in particular, the sheet having a thickness of 0.25 to 30 mm; and
Y) a press molding means for press molding the sheet in a plastic state, which is obtained by the electrical conduction heating means;
thereby to produce the press molded article comprising carbon fibers and a thermoplastic resin.

### <<Step A>>

The step A of the method for producing a press molded article of the present application is a step of preparing a sheet comprising carbon fibers and a thermoplastic resin.

The sheet comprises carbon fibers and a thermoplastic resin. Furthermore, as the carbon fibers and the thermoplastic resin, it is desirable to use those mentioned above.

The thickness of the sheet is not particularly limited but the thickness may be 0.25 to 30 mm. Preferably, the sheet may have a portion entirely having a thickness ranging from 2 to 25 mm. Furthermore, in a case where a conventional method, a method of heating a sheet from outside the sheet, is used to obtain a press molded article from the sheet having a portion having a thickness ranging from 2 to 25 mm, there arises problems such as that, due to longer time for heating the portion, the cost of the press molded article becomes higher even if the sheet could be press molded, and/or a press molded article not having predetermined mechanical performances can be obtained, and/or a press molded article itself cannot be obtained.

A structure of the sheet comprising carbon fibers and a thermoplastic resin is not particularly limited, but may meet the following conditions:

The sheet may have carbon fibers in an amount of 5 to 50 vol %, preferably 10 to 30 vol % in 100 vol % of the sheet.

Further, a volume resistivity of the sheet may be 5×10⁻³ to 1×10⁻¹ Ω·cm, preferably 2×10⁻² to 9×10⁻² Ω·cm.

### <<Step B>>

The step B is a step of heating the sheet by electrical conduction to transform the sheet into a plastic state. Furthermore, as for a production apparatus, a means for electrical conduction heating carries out the step B.

The phrase “electrical conduction” means that a direct current is applied to the sheet. The direct current may be applied along a long side or a short side of a nearly rectangular sheet.

Time of electrical conduction depends on the sheet used, specifically, on a kind of the thermoplastic resin of the sheet used, the volume resistivity of the sheet used, a size of the sheet used, an applied current value, and the like. For example, in a case where the thermoplastic resin is polypropylene, the sheet turns into a plastic state when the temperature of the sheet reaches 200° C., where press molding is possible. Thus, when the current value is set at ca. 200 to 2000 A, the plastic state may be obtained with an application time of about 2 to 5 seconds.

### <<Step C>>

The step C is a step of press molding the sheet in a plastic state. Further, as for the production apparatus, a means for press molding carries out the step C.

The means for press molding depends on characteristics of the sheet used, specifically, on a kind of the thermoplastic resin of the sheet and the like. However, a conventional means can be used.

While the step C is carried out after the step B, it is desirable that the step C is carried out immediately after the sheet is transformed into a plastic state in the step B. Therefore, as for the apparatus, X) the electrical conduction means and Y) the press molding means may be arranged so that the sheet in a plastic state obtained by the electrical conduction means can be immediately press molded.

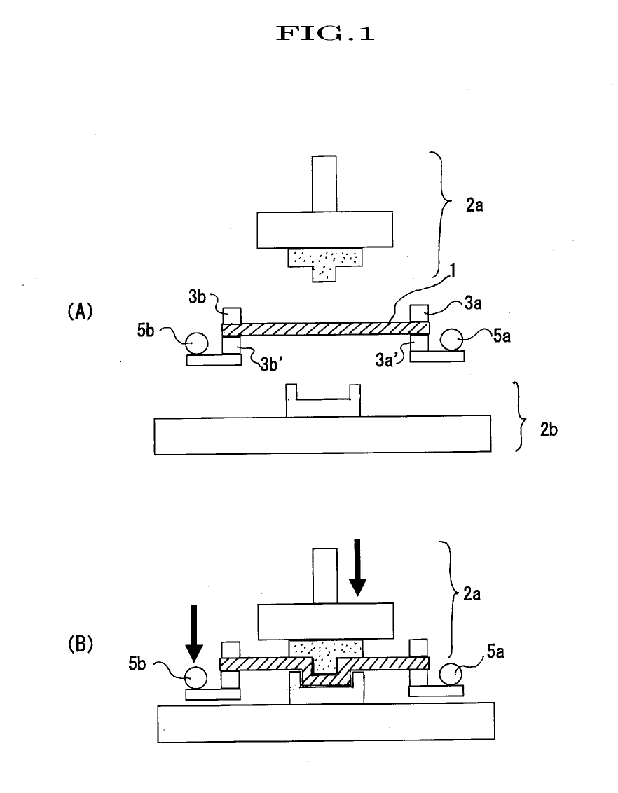

Specifically, the electrical conduction heating means and the press molding means may be arranged as shown in FIG. 1.

FIG. 1 shows one embodiment of a production apparatus of a press molded article, a state of electrical conduction heating and a subsequent state of press molding (shaping state).

FIG. 1(A) shows a state where the sheet 1 is heated by electrical conduction. In this state, the press molding means 2a and 2b are arranged away from the sheet 1. Here, the sheet 1 is gripped by a gripper 3a and 3a′ as well as a gripper 3b and 3b′. Further, the gripper 3a and 3a′ as well as the gripper 3b and 3b′ are held by a transport member 5a and 5b which transports (in a direction perpendicular to the paper surface) the sheet 1 to a predetermined position where heating and pressing are carried out.

The gripper 3a and 3a′ as well as the gripper 3b and 3b′ have electrical conductivity, and serve simultaneously as the electrical conduction heating means. When an electric current is applied to the grippers from electrodes which are not shown, an electric current is applied to the sheet 1, resulting in electrical conduction heating of the sheet 1.

FIG. 1(B) shows press molding of the sheet 1 which is in a plastic state after the electrical conduction heating. The press molding means 2a moves in a direction of arrow together with the sheet 1, the grippers 3a and 3a′, and 3b and 3b′ as well as the transport member 5a and 5b, and the sheet 1 is press molded in a desired shape.

Since the electrical conduction heating means and the press molding means are arranged as shown in FIG. 1, the sheet in a plastic state obtained by the electrical conduction heating means can be press molded immediately. Furthermore, the arrangement of the electrical conduction heating means and the press molding means shown in FIG. 1 is just one example, and is not limited thereto.

The above-described production method and/or the production apparatus can produce the press molded article:

Furthermore, as mentioned above, the press molded article may have the following characteristics.

The carbon fibers may have an amount of 5 to 50 vol %, preferably 10 to 30 vol % in 100 vol % of the press molded article.

The press molded article may have a volume resistivity of 5×10⁻³ to 1×10⁻¹ Ω·cm, preferably 2×10⁻² to 9×10⁻² Ω·cm.

The press molded article may have a thickness of 0.25 to 30 mm. Preferably, the press molded article may have a portion entirely having a thickness ranging from 2 to 25 mm.

An infrared absorption spectral intensity of the press molded article may have 0.05 or less, preferably 0.03 or less between the base lines in a wavenumber range of 1720 to 1770 cm⁻¹, as measured by a Fourier transform infrared spectrophotometer (FT-IR).

The present invention will be further explained in detail with reference to the following Examples, but is not limited thereto.

### EXAMPLE 1

### <Sheet>

Sheet A-1 comprising carbon fibers and a thermoplastic resin, obtained by forming a web using carbon fibers with a diameter of 6 μm and a length of 6 to 7 mm and impregnating this with polypropylene, had an uneven thickness of 0.5 to 8 mm and contained 20 vol % of carbon fibers in 100 vol % of the sheet. Furthermore, the sheet A-1 had a portion with a thickness of 2 to 8 mm, meaning that the sheet A-1 had a portion having a thickness ranging from 2 to 25 mm.

Further, the sheet A-1 had a volume resistivity of 2×10⁻² to 3×10⁻² Ω·cm.

### <Electrical Conduction Heating>

The sheet A-1 was heated by electrical conduction using an apparatus which is not shown.

It was once confirmed that temperature of the sheet A-1 became 200° C. by electrical conduction under conditions of current value: 400 A and time: 2 seconds, and subsequent electrical conduction heating was carried out under the same conditions.

### <Press Molding>

Immediately after the electrical conduction heating, press molding was carried out, to obtain a press molded article B-1. The press molding conditions were: time before application of pressure: about 5 seconds, pressure holding time: 60 seconds, and applied pressure: 20 MPa.

The press molded article B-1 obtained had a thickness of 0.5 to 8 mm and a volume resistivity of 2×10⁻² to 3×10⁻² Ω·cm, which are same as the sheet A-1 used.

Furthermore, the press molded article had a portion with a thickness of 2 to 8 mm, meaning that it had a portion having a thickness ranging from 2 to 25 mm.

### <Infrared Absorption Spectrum>

Further, an infrared absorption spectral intensity between the base lines in a wavenumber range of 1720 to 1770 cm⁻¹ of the press molded article B-1 was determined by a Fourier transform infrared spectrophotometer (FT-IR), resulting in the intensity of 0.03 at 1740 cm⁻¹.

### COMPARATIVE EXAMPLE 1

The sheet A-1, same as that prepared in Example 1, was used, and press molding was carried out by external heating, to obtain a press molded article B-C1 with external heating.

When an IR heater was used as the external heating means, it was found that the temperature reached 200° C. corresponding to a plastic state in 10 minutes by setting a preset temperature of the IR heater at 240° C. Press molding was carried out after heating under these conditions. Furthermore, with this heating, there was observed a thermal unevenness that the sheet is not heated all over (on the other hand, such a thermal unevenness was not observed in Example 1).

It shows that the sheet A-1 having a portion with a thickness of 2 to 8 mm produced a thermal unevenness when heated by an external heating means, while such a thermal unevenness was not observed in the present invention (Example 1).

An infrared absorption spectral intensity between the base lines in a wavenumber range of 1720 to 1770 cm⁻¹ of the press molded article B-C1 obtained was determined in a manner similar to Example 1 by a Fourier transform infrared spectrophotometer (FT-IR), resulting in the intensity of 0.1 at 1740 cm⁻¹.

In comparison of the measured values of the infrared absorption spectra of Example 1 with that of the Comparative Example 1, the presence of a carbonyl group was confirmed in Comparative Example 1. An evident oxidation was confirmed in the press molded article of Comparative Example 1. On the other hand, in Example 1, there was hardly confirmed oxidation such as that of Comparative Example 1. These results show that the present invention can provide a press molded article which is free from deterioration of mechanical properties caused by oxidative degradation.

### EXAMPLE 2

### <Sheet>

Sheet A-2 obtained by using plain weave carbon fibers, i.e. infinitely long carbon fiber bundles woven in a mesh form, and a polyamide resin (nylon 6) had an uneven thickness of 0.5 to 3 mm and contained 45 vol % of carbon fibers in 100 vol % of the sheet. Furthermore, the sheet A-2 had a portion with a thickness of 2 to 3 mm, meaning that it had a portion having a thickness ranging from 2 to 25 mm.

Further, the sheet A-2 had a volume resistivity of 5×10⁻³ to 1.5'10⁻² Ω·cm.

### <Electrical Conduction Heating>

The sheet A-2 was heated by electrical conduction using an apparatus which is not shown.

It was once confirmed that temperature of the sheet A-2 became 250° C. by electrical conduction under conditions of current value: 600 A and time: 2 seconds, and subsequent electrical conduction heating was carried out under the same conditions.

### <Press Molding>

Immediately after the electrical conduction heating, press molding was carried out, to obtain a press molded article B-2. The press molding conditions were: time before application of pressure: about 5 seconds, pressure holding time: 60 seconds, and applied pressure: 20 MPa.

The press molded article B-2 obtained had a thickness of 0.5 to 3 mm and a volume resistivity of 5×10⁻³ to 1×10⁻² Ω·cm, which are same as the sheet used.

### <Infrared Absorption Spectrum>

Further, an infrared absorption spectral intensity between the base lines in a wavenumber range of 1720 to 1770 cm⁻¹ of the press molded article B-2 was determined by a Fourier transform infrared spectrophotometer (FT-IR), resulting in the intensity of 0.03 at 1740 cm⁻¹.

### EXAMPLE 3

### <Sheet>

Sheet A-3 obtained by randomly dispersing and orienting short and long carbon fibers in a polypropylene resin had an uneven thickness of 0.5 to 5 mm and contained 30 vol % of carbon fibers in 100 vol % of the sheet. Furthermore, the sheet A-3 had a portion with a thickness of 2 to 5 mm, meaning that it had a portion having a thickness ranging from 2 to 25 mm.

Further, the sheet A-3 had a volume resistivity of 6×10⁻² to 9×10⁻² Ω·cm.

### <Electrical Conduction Heating>

The sheet A-3 was heated by electrical conduction using an apparatus which is not shown.

It was once confirmed that temperature of the sheet A-3 became 200° C. by electrical conduction under conditions of current value: 400 A and time: 2 seconds, and subsequent electrical conduction heating was carried out under the same conditions.

### <Press Molding>

Immediately after the electrical conduction heating, press molding was carried out, to obtain a press molded article B-3. The press molding conditions were: time before application of pressure: about 5 seconds, pressure holding time: 60 seconds, and applied pressure: 20 MPa.

The press molded article obtained had a thickness of 0.5 to 5 mm and a volume resistivity of 6×10⁻² to 9×10⁻² Ω·cm, which are same as the sheet used.

### <Infrared Absorption Spectrum>

Further, an infrared absorption spectral intensity between the base lines in a wavenumber range of 1720 to 1770 cm⁻¹ of the press molded article was determined by a Fourier transform infrared spectrophotometer (FT-IR), resulting in the intensity of 0.03 at 1740 cm⁻¹.

### EXAMPLE4

### <Sheet>

Sheet A-4 obtained by using infinitely long carbon fiber bundles woven in a tape form of 5 to 30 mm width and an aromatic nylon resin had an uneven thickness of 0.5 to 2 mm and contained 30 vol % of carbon fibers in 100 vol % of the sheet.

Further, the sheet A-4 had a volume resistivity of 5×10⁻³ to 9×10⁻³ Ω·cm.

### <Electrical Conduction Heating>

The sheet A-4 was heated by electrical conduction using an apparatus which is not shown.

It was once confirmed that temperature of the sheet became 270° C. by electrical conduction under conditions of current value: 600 A and time: 2 seconds, and subsequent electrical conduction heating was carried out under the same conditions.

### <Press Molding>

Immediately after the electrical conduction heating, press molding was performed to obtain a press molded article B-4. The press molding conditions were: time before application of pressure: about 5 seconds, pressure holding time: 60 seconds, and applied pressure: 20 MPa.

The press molded article obtained had a thickness of 0.5 to 2 mm and a volume resistivity of 5×10⁻³ to 9×10⁻³ Ω·cm, which are same as the sheet used.

### <Infrared Absorption Spectrum>

Further, an infrared absorption spectral intensity between base lines in a wavenumber range of 1720 to 1770 cm⁻¹ of the press molded article was determined by a Fourier transform infrared spectrophotometer (FT-IR), resulting in the intensity of 0.03 at 1740 cm⁻¹.

### EXAMPLE 5

### <Sheet>

A two-layer laminated sheet A-5 was used, which was obtained by laminating the sheet A-1 obtained in Example 1 and the sheet A-3 obtained in Example 3.

The two-layer laminated sheet A-5 had an uneven thickness of 1 to 13 mm and contained 25 vol % of carbon fibers in 100 vol % of the sheet. Furthermore, the two-layer laminated sheet A-5 had a portion with a thickness of 2 to 13 mm, meaning that the sheet A-5 had a portion having a thickness ranging from 2 to 25 mm.

Further, the two-layer laminated sheet A-5 had a volume resistivity of 3.5×10⁻² to 8×10⁻² Ω·cm.

### <Electrical Conduction Heating>

The two-layer laminated sheet A-5 was heated by electrical conduction using an apparatus which is not shown.

It was once confirmed that temperature of the sheet became 200° C. by electrical conduction under conditions of current value: 400 A and time: 2 seconds, and subsequent electrical conduction heating was carried out under the same conditions.

### <Press Molding>

Immediately after the current conduction heating, press molding was carried out, to obtain a press molded article B-5. The press molding conditions were: time before application of pressure: about 5 seconds, pressure holding time: 60 seconds, and applied pressure: 20 MPa.

The press molded article B-5 obtained had a thickness of 1 to 13 mm and a volume resistivity of 3.5×10⁻² to 8×10⁻² Ω·cm, which are same as the sheet A-5 used.

### <Infrared Absorption Spectrum>

Further, an infrared absorption spectral intensity between the base lines in a wavenumber range of 1720 to 1770 cm⁻¹ of the press molded article B-5 was determined by a Fourier transform infrared spectrophotometer (FT-IR), resulting in the intensity of 0.03 at 1740 cm⁻¹.

### EXAMPLE 6

### <Sheet>

A three-layer laminated sheet A-6 was used, which was obtained by disposing the sheets A-1 obtained in Example 1 on and under the sheet A-3 obtained in Example 3.

The three-layer laminated sheet A-6 had an uneven thickness of 1.5 to 21 mm and contained 25 vol % of carbon fibers in 100 vol % of the sheet. Furthermore, the three-layer laminated sheet A-6 had a portion with a thickness of 2 to 21 mm, meaning that the sheet A-6 had a portion having a thickness ranging from 2 to 25 mm.

Further, the laminated sheet A-6 had a volume resistivity of 2.5×10⁻² to 6×10⁻² Ω·cm.

### <Electrical Conduction Heating>

The three-layer laminated sheet A-6 was heated by electrical conduction using an apparatus which is not shown.

It was once confirmed that temperature of the entire sheet became 200° C. by electrical conduction under conditions of current value: 400 A and time: 2 seconds, and subsequent electrical conduction heating was carried out under the same conditions.

### <Press Molding>

Immediately after the current conduction heating, press molding was carried out, to obtain a press molded article B-6. The press molding conditions were: time before application of pressure: about 5 seconds, pressure holding time: 60 seconds, and applied pressure: 20 MPa.

The press molded article B-6 obtained had a thickness of 1.5 to 21 mm and a volume resistivity of 2.5×10⁻² to 6×10⁻² Ω·cm, which are same as the sheet A-6 used.

### <Infrared Absorption Spectrum>

Further, an infrared absorption spectral intensity between the base lines in a wavenumber range of 1720 to 1770 cm⁻¹ of the press molded article B-6 was determined by a Fourier transform infrared spectrophotometer (FT-IR), resulting in the intensity of 0.03 at 1740 cm⁻¹.

### COMPARATIVE EXAMPLE 2

The three-layer laminated sheet A-6, which was the same as that prepared in Example 6, was used, and external heating was performed using an external heating means, specifically the IR heater used in Comparative Example 1.

However, it was difficult to have the three-layer laminated sheet A-6 heated to the inside thereof and it was confirmed that a plastic state necessary for the press molding could not be obtained.

In comparison of Example 6 with Comparative Example 2, it could be confirmed that, when the three-layer laminated sheet A-6 having a portion of 2 to 21 mm in thickness was used, external heating and subsequent press molding were difficult in Comparative Example 2, while heating and press molding could be carried out in Example 6.

1. A press molded article comprising carbon fibers and a thermoplastic resin, wherein
i) an amount of the carbon fibers ranges from 5 to 50 vol % in 100 vol % of the press molded article,
ii) a volume resistivity of the press molded article ranges from 5×10⁻³ to 1×110⁻¹ Ω·cm, and
iii) a thickness of the press molded article ranges from 0.25 to 30 mm.

2. The press molded article according to claim 1, wherein the carbon fibers form a carbon fiber layer.

3. The press molded article according to claim 1, wherein the thermoplastic resin is at least one selected from the group consisting of polyesters, polyolefins, polystyrenes, polyurethanes, polyamides, polyimides, polyketones, polycarbonates, polysulfones, and polyethers.

4. A method for producing a press molded article comprising carbon fibers and a thermoplastic resin from a sheet comprising carbon fibers and a thermoplastic resin, the method comprising the steps of:
A) preparing the sheet comprising carbon fibers and the thermoplastic resin;
B) heating the sheet by electrical conduction to transform the sheet into a plastic state; and
C) press molding the sheet in a plastic state; to obtain the press molded article.

5. An apparatus for producing a press molded article comprising carbon fibers and a thermoplastic resin, comprising:
X) an electrical conduction heating means for heating a sheet comprising carbon fibers and a thermoplastic resin; and
Y) a press molding means for press molding the sheet in a plastic state obtained by the electrical conduction heating means.

6. The apparatus according to claim 5, wherein the electrical conduction heating means and the press molding means are arranged so that the sheet in a plastic state obtained by the electrical conduction heating means can be immediately press molded.

7. The press molded article according to claim 2, wherein the thermoplastic resin is at least one selected from the group consisting of polyesters, polyolefins, polystyrenes, polyurethanes, polyamides, polyimides, polyketones, polycarbonates, polysulfones, and polyethers.
